(19) United States
(12) Patent Application Publication
(10) Pub. No.: US 2026/0273384 A1
(43) Pub. Date: Sep. 17, 2026

(54) SYSTEMS AND METHODS FOR CONDUCTING A MULTI-PART LOTTERY GAME

(71) Applicant: GDC Gaming & Entertainment Ltd., Pickering (CA)

(72) Inventors: Vatche TOROSSIAN, Pickering (CA); Don DREW, Uxbridge (CA); Jared MILLICAN, Toronto (CA)

(21) Appl. No.: 19/162,489

(22) PCT Filed: Mar. 6, 2024
(86) PCT No.: PCT/CA2024/050274

§ 371 Date: Sep. 5, 2025

Related U.S. Application Data
(60) Provisional application No. 63/450,341, filed on Mar. 6, 2023.

(51) Int. Cl. A63F 3/06; A63F 3/08; A63F 11/00

(52) U.S. Cl. CPC A63F 3/0605; A63F 3/0665; A63F 3/08; A63F 11/0074; A63F 2011/0086

(57) ABSTRACT

An instant gaming ticket comprises multiple play areas with each play area providing a set of values for play in a primary lottery-type game defined by gameplay rules and one or more winning conditions. A winning value satisfying one of the winning conditions of a primary game in a certain play area may be dependent on the set of values assigned to another primary game in another play area. The instant gaming ticket may optionally support secondary games. A winning value satisfying one of the winning conditions of a secondary game may be dependent on one or more sets of assigned values for the primary games.

### RELATED APPLICATIONS

This application claims priority from U.S. application No. 63/450,341 filed Mar. 6, 2023 entitled “SYSTEMS AND METHODS FOR CONDUCTING A MULTI-PART LOTTERY GAME”. For the purposes of the United States, this application claims the benefit under 35 USC § 119 of U.S. application No. 63/450,341 filed Mar. 6, 2023 entitled “SYSTEMS AND METHODS FOR CONDUCTING A MULTI-PART LOTTERY GAME”, which is incorporated herein by reference in its entirety.

### TECHNICAL FIELD

The present disclosure relates to instant game tickets, electronic lottery-type gaming systems, and methods of conducting a multi-part lottery-type game. Particular embodiments may be implemented or otherwise provided through computers and/or electronic gaming systems.

### BACKGROUND

Lottery-type games of chance have exhibited enduring popularity over the past several decades. Such games usually allow a player to make a relatively small payment or “investment” in exchange for a chance of winning a relatively large reward. The games provide entertainment value for players and have remained popular as a reliable source of revenue for lottery operators (e.g. municipalities, charities, business establishments, etc.).

Lottery-type games are traditionally played on scratch tickets (i.e., instant gaming tickets, scratch cards, etc.). These tickets are designed and printed with predetermined information to provide games that have a predetermined result. While such tickets are good for providing instant gratification to players who purchase the winning tickets, they offer limited gameplay experience due to their deterministic nature.

As entertainment technology continues to develop and the attention span of average consumers continues to decrease, there is a growing challenge in the gaming industry to design lottery-type games that are enticing enough to maintain player participation. Some instant game tickets have been designed to provide more extended gameplay. However, these games are typically difficult to play and not appealing to the average person.

There remains a need for new lottery-type games and gaming system designs.

There remains a need for games that provide multiple areas of play to increase excitement and gameplay variety for the average player. There remains a need for games that are non-deterministic or semi-deterministic to increase anticipation for the average player.

There remains a need for electronic and/or physical gaming tickets that are designed to support such games.

### SUMMARY OF THE DISCLOSURE

One aspect of the invention relates to a method for conducting a lottery-type game. The lottery-type game may be a game of chance, skill, or a combination of chance and skill. The method comprises providing a ticket having first and second play areas, assigning a first set of values to the first play area, and assigning a second set of values to the second play area. The first and second play areas each support a primary lottery-type game defined by its gameplay rules and winning condition(s). The first set of values is assigned based on at least one of the winning conditions of the first primary game to facilitate gameplay of the first primary game. The second set of values is assigned based on at least one of the winning conditions of the second primary game to facilitate gameplay of the second primary game. At least one of the winning values for satisfying a winning condition of the second primary game is dependent on the first set of values.

In some embodiments, a second winning value for satisfying a second additional winning condition of the second primary game is independent of the first set of values. In some embodiments, at least one winning value for satisfying one of the winning conditions of the first primary game is dependent on the second set of values. In such embodiments, a second winning value for satisfying a second additional winning condition of the first primary game may be independent of the second set of values.

In some embodiments, the first and second play areas collectively support a secondary lottery-type game defined by its gameplay rules and winning condition(s). A first winning value satisfying a first winning condition of the secondary game may be dependent on the first set of values and the second set of values. A second winning value satisfying a second winning condition of the secondary game may be independent of the first set of values and dependent on the second set of values. The first primary game may be an instant win game, a raffle game, or an interactive game. The secondary game may be an instant win game, a raffle game, or an interactive game.

Other aspects of the invention relate to an instant gaming ticket. The instant gaming ticket comprises at least a first play area and a second play area. The first play area provides a first set of values for play in a first primary lottery-type game defined by its gameplay rules and winning condition(s). The second play area provides a second set of values for play in a second primary lottery-type game defined by its gameplay rules and winning condition(s). At least one winning value for satisfying a winning condition of the second primary game is dependent on the first set of values.

In some embodiments, the first play area and the second play area are located on the same surface. The second play area may be located beneath the first play area. The first play area and the second play area may be located on different surfaces. In some embodiments, the first set of values is concealed by a cover. The cover may comprise an opaque scratch-off coating and/or a removable flap. In some embodiments, the ticket includes a third play area providing a third set of values for play in a third primary lottery-type game defined by its gameplay rules and winning condition(s). At least one winning value for satisfying one of the winning conditions of the third primary game may be dependent on the first set of values. At least one winning value for satisfying one of the winning conditions of the third primary game may be dependent on the second set of values. At least one winning value for satisfying a winning condition of a secondary game may be dependent on the first set of values and the second set of values.

Other aspects of the invention relate to a computer-implemented method for conducting a lottery-type game. The method comprises defining gameplay rules and winning condition(s) for a first primary game and a second primary game, providing a first set of values in the first play area, and providing a second set of values in the second play area. The first set of values are randomly generated based on the gameplay rules of the first primary game, the second set of values are randomly generated based on the gameplay rules of the second primary game. At least one winning value for satisfying one of the winning conditions of the second primary game is dependent on the first set of values.

In some embodiments, the second primary game is an interactive game. In some embodiments, the method comprises announcing the winning condition of the second primary game after providing the first and second set of values in the first and second play areas.

In addition to the exemplary aspects and embodiments described above, further aspects and embodiments will become apparent by reference to the drawings and by study of the following detailed descriptions.

### BRIEF DESCRIPTION OF THE DRAWINGS

Features and advantages of the embodiments of the present invention will become apparent from the following detailed description, taken in with reference to the appended drawings in which:

FIG. 1 is a schematic illustration of a gaming ticket according to an example embodiment.

FIG. 2 illustrates examples of dependent and semi-dependent play areas that may be provided by the FIG. 1 gaming ticket.

FIG. 3 illustrates examples of secondary games that may be provided by the FIG. 1 gaming ticket.

FIG. 4 illustrates an example of a type of primary game that may be provided by the FIG. 1 gaming ticket.

FIG. 5 is a block diagram of an example embodiment of a machine for implementing games of the type provided by the FIG. 1 gaming ticket.

FIG. 6 depicts a physical gaming ticket according to an example embodiment.

FIG. 6A illustrates an example outer front surface of the FIG. 6 gaming ticket. FIG. 6B illustrates an example inner front surface of the FIG. 6 gaming ticket. FIG. 6C illustrates an example inner rear surface of the FIG. 6 gaming ticket. FIG. 6D illustrates an example outer rear surface of the FIG. 6 gaming ticket.

FIG. 7 depicts a graphical user interface (GUI) for playing an electronic gaming ticket according to an example embodiment.

### DETAILED DESCRIPTION

The description which follows, and the embodiments described therein, are provided by way of illustration of examples of particular embodiments of the principles of the present invention. These examples are provided for the purposes of explanation, and not limitation, of those principles and of the invention.

Aspects of the present invention relate to lottery-type games comprising games of chance, skill, or a combination of chance and skill, or other types of games of chance and/or skill, that provide enhanced player experience by providing a player with the opportunity to participate in multiple different games simultaneously. Such lottery-type games may be characterized herein as methods of conducting a multi-part game, “multi-part gaming methods”, or “gaming methods”. The gaming methods described herein are designed to provide one or more (e.g., two, three, four, five, etc.) play areas to the player. Each play area can support a different game. The games can include, but are not limited to, a combination of instant win games (e.g., break open games, pull-tab games, scratch-off games, etc.), raffle style games (e.g., games provided via a live online draw, a live stream, broadcast, a pre-recorded video, a web site posting, etc.), interactive lottery games (e.g., bingo-oriented games, etc.), and special symbol and/or indicia games as described in more detail below.

In accordance with aspects of the invention, some play areas may be dependent or semi-dependent on other play areas. For the purposes of facilitating the description, a second play area is “dependent” on a first play area if the gameplay or outcome in the second play area is completely determined by the gameplay or outcome in the first play area. For the purposes of facilitating the description, a second play area is “semi-dependent” on a first play area if the gameplay or outcome in the second play area is partially determined (i.e., affected but not completely determined) by the gameplay or outcome in the first play area. For the purposes of facilitating the description, two play areas are “co-dependent” on each other if the gameplay, outcome, or chances of winning in each play area is dependent or semi-dependent on the gameplay, outcome, or chances of winning in the other play area. For the purposes of facilitating the description, a second play area is “independent” of a first play area if the gameplay, chances of winning and outcome in the second play area are completely independent of the gameplay, chances of winning and outcome in the first play area.

Gaming methods described herein may provide the player with one or more opportunities to win monetary and/or other identified or sponsored prizes. Such gaming methods may be particularly well suited for fundraising activities. Some embodiments are computer-implemented methods (i.e., the gaming methods are implemented entirely through a computer, phone, tablet, electronic gaming system, or the like). Other embodiments have a combination of digital components and physical components (i.e., the gaming methods are implemented through both a computer, or the like, and a physical game card, or the like).

Lottery-type gaming tickets described herein may be designed to support various gaming methods. Embodiments of lottery-type gaming tickets include electronic gaming tickets and physical gaming tickets. The term “instant gaming ticket” may be used herein to describe both electronic and physical embodiments of a lottery-type gaming ticket.

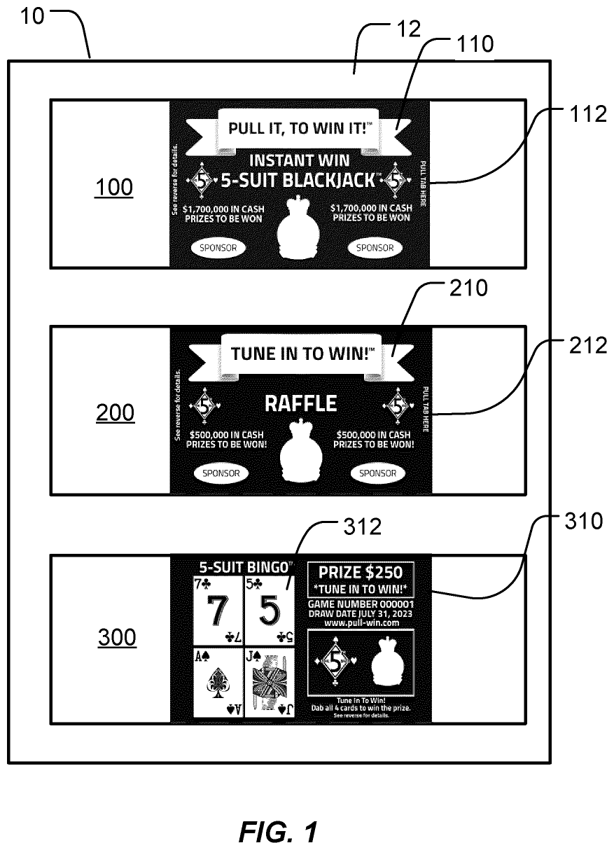

FIG. 1 is a schematic illustration of an instant gaming ticket 10 according to an example embodiment. Instant gaming ticket 10 may be provided through electronic means or a physical lottery ticket. Gaming ticket 10 comprises a first play area 100, a second play area 200, and a third play area 300. In general, gaming ticket 10 may comprise any suitable number of play areas (e.g., four, five, six, seven, etc.). The play areas may be provided on one or more surfaces 12 of gaming ticket 10. In the illustrated embodiment, the play areas are spaced apart vertically on a single surface 12. In other embodiments, the play areas may be spaced apart horizontally or located at other suitable locations of gaming ticket 10 (e.g., located on opposite sides of a playing card, opposite corners of a surface, different surfaces, etc.).

Each play area supports a primary lottery-type game of chance or a “primary game”. Such games can be defined or otherwise characterized by their gameplay rules (i.e., how to play the game) and winning conditions (i.e., how to win in the game). Each game can have one or more winning conditions. Examples of winning conditions for some lottery-type games include, but are not limited to, making a straight line in a bingo game, matching the winning number in a raffle game, making a specific hand in a poker game, etc. Typically, each winning condition can be satisfied by one or more winning values. For example, the winning condition in an instant win game may require three matching numbers in a row. As another example, the winning values may comprise combinations of numbers that match each other to satisfy the winning condition.

Each play area may support the same type or a different type of primary game.

In the example embodiment illustrated in FIG. 1, first playing area 100 supports an instant win game 110, second playing area 200 supports a raffle game 210, and third playing area 300 supports an interactive game 310. For each play area 100, 200, 300, a set of values may be assigned thereto based on at least one of the winning conditions of its respective game 110, 210, 310 in order to facilitate gameplay. Some of the values may be characterized as winning values which satisfy at least one of the winning conditions of games 110, 210, 310.

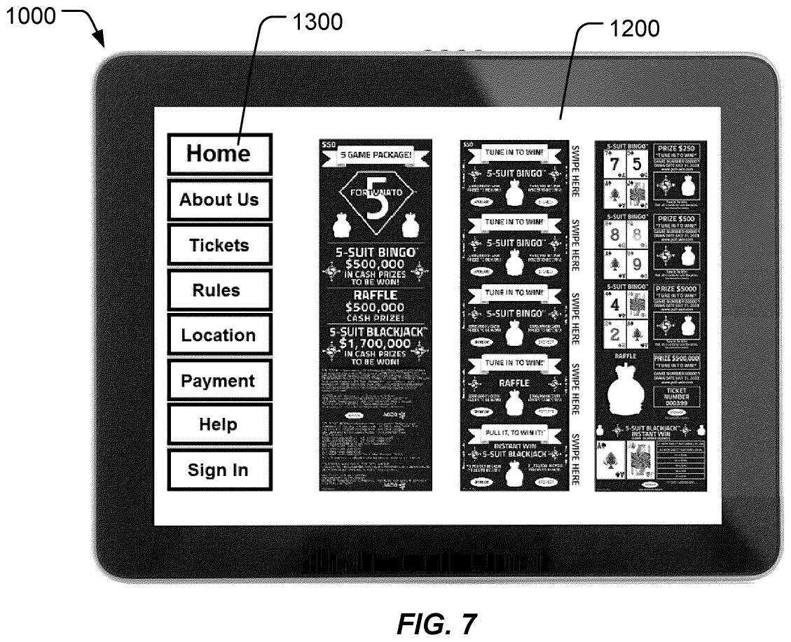

In instant win game 110, the player reveals a covered portion 112 in first playing area 100 and compares the uncovered value or information (e.g., a number, a symbol, an indicia, etc.) with a pre-determined winning condition or criteria to assess whether they have won a prize or otherwise obtained a favorable outcome. Covered portion 112 may be covered with a tab, a scratchable cover, or the like. Covered portion 112 may be revealed by pulling the tab, scratching off the scratchable cover, or conducting like actions. In electronic or computer-implemented embodiments, covered portion 112 may be uncovered by an interaction using a graphical user interface (e.g., see FIG. 7) such as by using a mouse or pointer, or finger or stylus in the case of a touch-screen display, to click on or hover over the cover covering the covered portion 112 displayed on a screen, etc.

In raffle game 210, the player compares a uniquely assigned value 212 or information (e.g., a number, a word, a string of characters, etc.) with a winning value announced in the future. The winning value may be determined randomly. For example, the winning value may be determined via a draw that is communicated via a live stream, a broadcast, a recorded video, etc. The draw may be a live draw that is conducted in person or broadcasted to the player via an online interface or platform or revealed to the player in another electronic format. The assigned value 212 may be printed directly on a surface 12 of gaming ticket 10. The assigned value 212 may be covered by a tab, a scratchable surface, or the like, as illustrated in FIG. 1.

In interactive game 310, the player compares a random combination or arrangement of assigned values 312 with values selected in the future. In the example illustrated in FIG. 1, the assigned values 312 include the “seven of clubs”, “five of clubs”, “ace of spades”, and “jack of spades”. Each “value” may be defined by one or more types of “figures” (e.g., numbers, ranks, etc.). As an example, the “five of clubs” value is defined by the number “five” and the rank “clubs”.

The selected values are typically determined randomly and may be revealed individually in sequence. For example, the selected values may be revealed sequentially via a live online broadcast, an in-person announcement, or both. Interactive game 310 may be played by matching individual assigned values 312 on ticket 10 to the selected winning values being drawn until a winning criteria is met (e.g., a certain number of assigned values 312 has been matched with selected values, a certain pattern has been formed by the assigned values matching the selected values, etc.). As an example, a winning condition of interactive game 310 may require making a straight vertical line or a straight horizontal line with the values 312 provided in play area 300. In this example, the winning combination of values 312 for game 310 of ticket 2 is any one of: “seven of clubs” and “five of clubs”, “seven of clubs” and “ace of spades”, “five of clubs” and “jack of spades”, and “ace of spades” and “jack of spades”. Interactive game 310 may be played by multiple users simultaneously until a winning combination of values for a user has been announced. In some embodiments, the combination or arrangement of assigned values 312 may be covered by a tab or a scratchable surface.

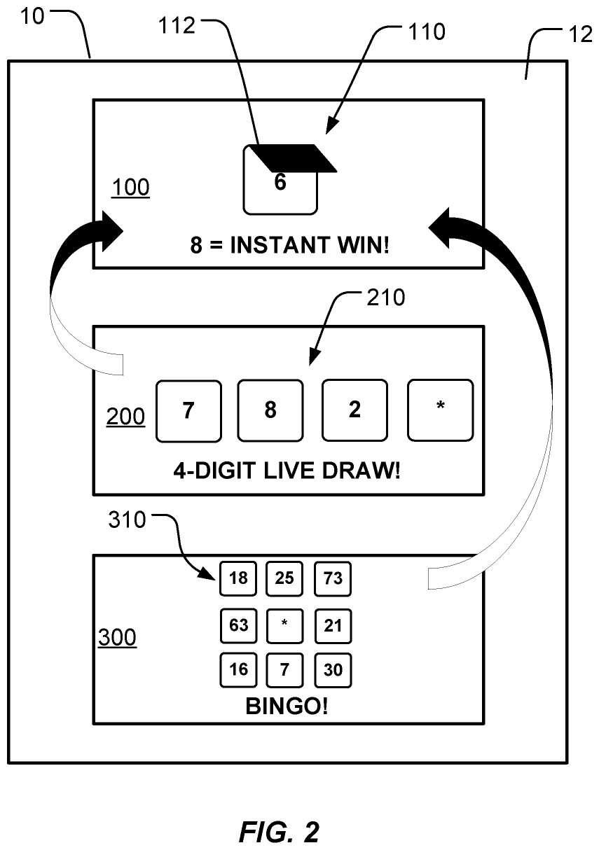

As described above, aspects of the invention relate to methods of conducting a lottery-type game to provide play areas that are dependent or semi-dependent on other play areas. Features of dependent and semi-dependent play areas are described in more detail below with reference to FIG. 2.

In the example embodiment illustrated in FIG. 2, second play area 200 supports a 4-digit live draw raffle game 210 that is dependent on the gameplay of instant win game 110 in first play area 100. In general, second play area 200 may support other types of games, including other types of raffle games or raffle games involving winning numbers with five digits, six digits or more. In the illustrated embodiment, the outcome of raffle game 210 is dependent on the number provided in the covered area 112 of instant win game 110. In particular, the 4-digit number in second play area 200 comprises three digits provided in second play area 200 and one digit corresponding to the covered number provided in first play area 100. Hence, whether or not the player has the 4-digit number satisfying the winning condition of raffle game 210 is considered to be dependent, at least in part, on the number provided in covered area 112 of instant win game 110.

In other embodiments, the dependent digit in raffle game 210 may be based on the outcome of the game in first play area 100. For example, the last digit of the assigned number in raffle game 210 may be a first number (e.g., “4”) if the player wins the game in play area 100, or a second number (e.g., “9”) if the player loses the game in play area 100. Since the outcome of raffle game 210 is determined by the covered number in instant win game 110, second play area 200 is considered to be “dependent” on first play area 100.

In particular embodiments, for tickets 10 which provide at least two play areas, the second primary game in the second play area may comprise winning values that are dependent on the first set of values assigned to the first primary game in the first play area. Each primary game may have one or more winning conditions, and each corresponding play area may be assigned one or more values which either satisfy or do not satisfy the one or more winning conditions.

In the example embodiment illustrated in FIG. 2, third play area 300 supports an interactive bingo-style game 310 that is influenced by, but not completely dependent on, the gameplay of instant win game 110 in first play area 100. In the illustrated embodiment, the outcome of interactive game 310 is affected by the assigned number provided in the covered area 112 of instant win game 110. In particular, the array of numbers in third play area 300 comprises eight (8) numbers provided in third play area 300 and one number corresponding to the covered number provided in first play area 100. In the illustrated embodiment of interactive game 310, some of the winning values for satisfying the winning condition (i.e., making a straight line) are dependent on the centered number (which is denoted by an asterisk * in the illustrated embodiment), which corresponds to the number provided in the covered area 112 of instant win game 110, while other winning values for satisfying the winning condition are independent of the centered number.

In other embodiments, the dependent number in interactive game 310 may be based on the outcome of the game in first play area 100. For example, the centered number of game 310 may be a first number (e.g., “24”) if the player wins the game in play area 100, or a second number (e.g., “91”) if the player loses the game in play area 100. Since the outcome of interactive game 310 is influenced but not completely determined by the covered number in instant win game 110 (i.e., a player can still win by connecting the numbers in the top row, last column, etc.), third play area 300 is considered to be “semi-dependent” on first play area 100.

Further aspects of the invention relate to methods of conducting a lottery-type game to provide one or more secondary games in addition to the one or more primary games described above.

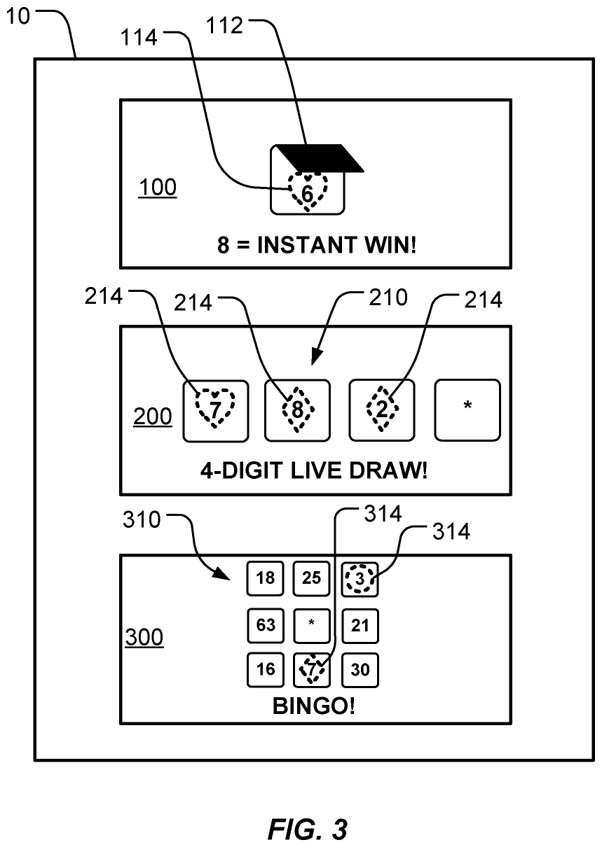

Like primary games, secondary games can be defined or otherwise characterized by their gameplay rules and winning conditions. In contrast to primary games that are contained and played within a single play area, secondary games are played across multiple play areas. Secondary games may be dependent or semi-dependent on primary games. Secondary games provide the player with extra or secondary opportunities to win. Features of secondary games are described in more detail below with reference to FIG. 3.

In the example embodiment illustrated in FIG. 3, ticket 10 provides a secondary game of 5-card poker. In the illustrated embodiment, the player has additional or secondary opportunities to win prizes by making certain 5-card poker hands from the cards 114, 214, 314 that have been made available to the player as part of the primary games. For example, the player may win a small prize for making a single pair with the cards, or a large prize for making a royal flush with the cards. For the purposes of facilitating the description, the term “card” is used herein at times to refer to a value comprising a rank and a suit.

The selection of different cards may include a large number of different varieties of ranks and/or suits. For example, the selection of different cards may include those in a standard 52-card deck and thirteen additional cards (i.e., ranks A to K) from an additional suit (e.g., a special suit depicted in the drawings as a circle) to form a 65-card deck. As another example, the selection of different cards may correspond to the selection of cards in a standard 52-card deck (i.e., ranks of A to K, and suits of spade, diamond, heart, and clubs). As another example, the selection of different cards may include a reduced selection of cards from the standard 52-card deck (i.e., ranks of A to K, and suits of spade, diamond, and clubs).

The selection of different cards may also include multiple decks, such as between one to eight decks of the 65-card deck to support a variety of different secondary games and/or secondary game variations.

The cards that are available for the secondary game may be dependent or independent from the numbers, or other values and information, assigned to ticket 10 in the primary games. In the embodiment illustrated in FIG. 3, the cards for the secondary game are dependent on the assigned numbers for the primary games played across first play area 100, second play area 200, and third play area 300. In particular, first play area 100 provides the six of hearts card 114, second play area 200 provides the seven of hearts, eight of diamonds, and two of diamonds cards 214, and third play area 300 provides the seven of diamonds, and three of circle cards 314. The cards for the secondary game may also be dependent on the results or outcome of an interactive component of a primary game. For example, ticket 10 may stipulate that only drawn numbers from bingo game 300 can be used as cards for the secondary game. In this example, if the number “3” was drawn in bingo game 300 and the number “7” was not, then only the three of circle card can be used in the secondary game.

In particular embodiments, for tickets 10 which provide two or more play areas for primary games, a secondary game may comprise one or more winning values that are dependent on only one or both of the first and second set of values assigned to the first and second primary games in the first and second play areas. For example, a first winning value satisfying a first one of the winning conditions of the secondary game may be dependent on both the first set of values assigned to the first primary game and the second set of values assigned to the second primary game. As another example, a second winning value satisfying a second one of the winning conditions of the secondary game may be dependent on the first set of values assigned to the first primary game, but independent of the second set of values.

In the illustrated embodiment, the selection of different cards include thirteen ranks (i.e., ranks 1 to 13) and five suits (i.e., suits of heart, diamond, club, spade, and circle) to form a 65-card deck. This can provide the player with a gameplay experience that is different from the usual. In other embodiments, the selection of different cards can include other combinations of ranks and suits. For example, the selection of different cards can include fifteen or more ranks and six or more suits. The card selection may be based on the gameplay rules and/or winning conditions of the secondary game.

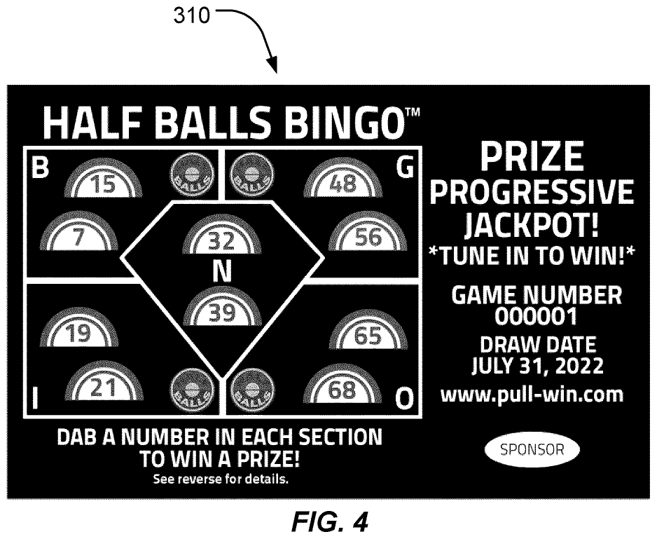

FIG. 4 illustrates an example of an alternative embodiment of interactive bingo-style game 310. In the illustrated embodiment, the winning condition requires a number from each of the “B”, “I”, “N”, “G”, and “O” sections of the ticket to be announced or otherwise selected in an interactive draw. With the assigned values of “15” and “7” in the “B” section, “19” and “21” in the “I section, “32” and “39 in the “N” section, “48” and “56” in the “G” section, and “65” and “68” in the “O” section, an example of a winning combination of values for the illustrated ticket is “7”, “19”, “32”, “48” and “65”. Other example winning combinations for the illustrated ticket include, but are not limited to: “15”, “19”, “32”, “48” and “65”; “15”, “19”, “32”, “48” and “68”; etc.

Gaming methods described herein may be performed or otherwise implemented using specifically designed gaming machines or gaming tables. Such machines or tables may comprise dedicated hardware, configurable hardware, programmable data processors configured by the provision of software (which may optionally comprise “firmware”) capable of executing on the data processors, and/or other types of special purpose computers. Examples of specifically designed hardware include, but are not limited to, logic circuits, application-specific integrated circuits (“ASICs”), large scale integrated circuits (“LSIs”), very large scale integrated circuits (“VLSIs”), and the like. Examples of configurable hardware include, but are not limited to, programmable logic devices, programmable array logic (“PALs”), programmable logic arrays (“PLAs”), field programmable gate arrays (“FPGAs”), and the like. Examples of programmable data processors include, but are not limited to, microprocessors, digital signal processors (“DSPs”), embedded processors, graphics processors, math co-processors, general purpose computers, server computers, cloud computers, mainframe computers, computer workstations, and the like.

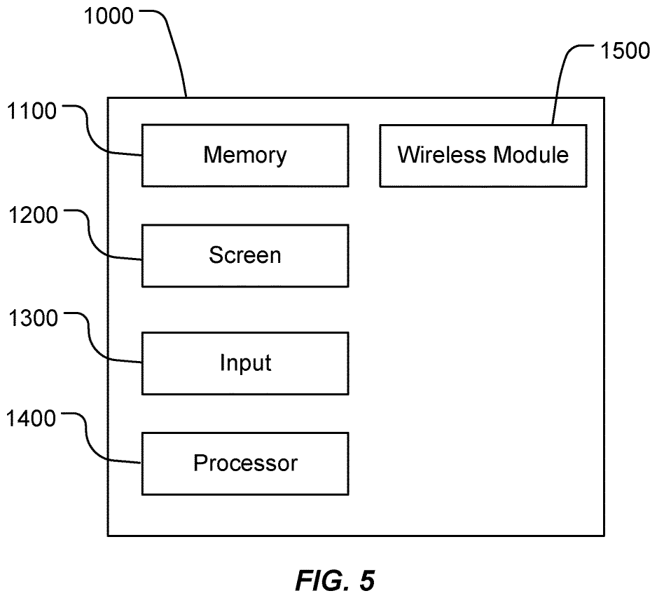

FIG. 5 is a block diagram of a gaming machine 1000 according to an example embodiment. Gaming machine 1000 may be configured to define gameplay rules and one or more winning conditions for a first primary game and a second primary game. Gaming machine 1000 comprises a memory 1100 for storing the gameplay rules and associated winning conditions of various lottery-type games. Memory 1100 may also store other data for supporting an electronics gaming ticket, such as display data for providing a graphical user interface (GUI) on screen 1200 of gaming machine 1000. The GUI allows the user to interact with and participate in a variety of different games provided by gaming machine 1000 (e.g., see FIG. 7). In some cases, a user or player can interact with gaming machine 1000 through an input 1300 (e.g., a touchscreen feature provided by screen 1100). For example, a user can in some cases uncover a covered portion of the electronics gaming ticket by clicking or touching the covered portion through input 1300. A processor 1400 may randomly assign values in a game provided by machine 1000 based on its gameplay rules and winning conditions. For example, processor 1400 may randomly generate first and second sets of values based on the gameplay rules of a first and second primary game. Processor 1400 may also process player input received through input 1300 and/or external input received through wireless module 1500 to determine whether the player has won or obtained a favorable result in the games.

A wide range of variations are possible within the scope of the present invention. These variations are described in more detail below and may be applied to all of the embodiments described above, as suited, and without limitation.

At least one of the play areas may include means for initially concealing at least one game symbol, indicia, number, or the like, displayed upon the play area. The concealing means may include a repositionable flap-like member, a break-open/pull-tab, a scratch-off surface, and/or other forms of concealment. Similarly, the monetary and/or other identified prize, sponsored or otherwise, may also be concealed initially.

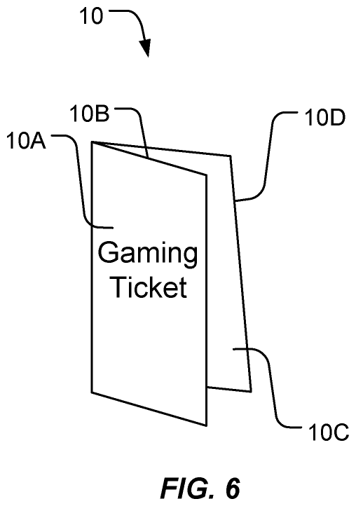

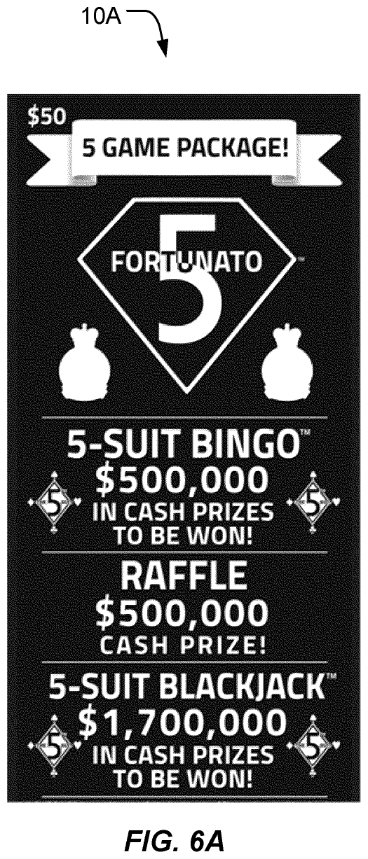

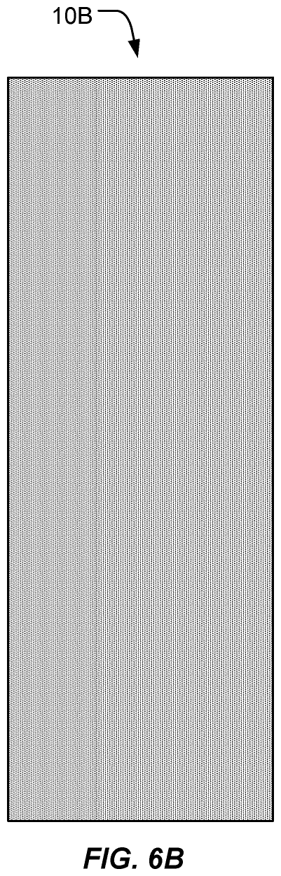

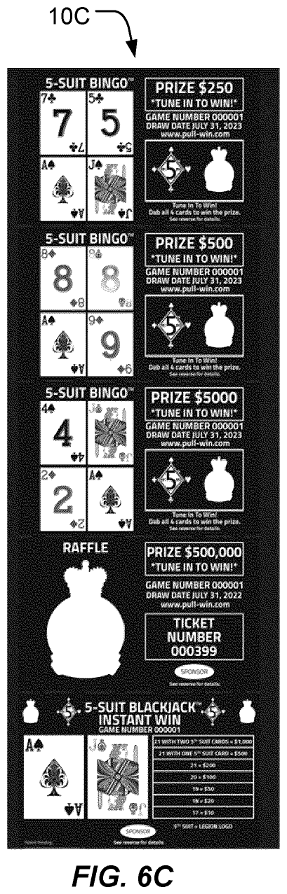

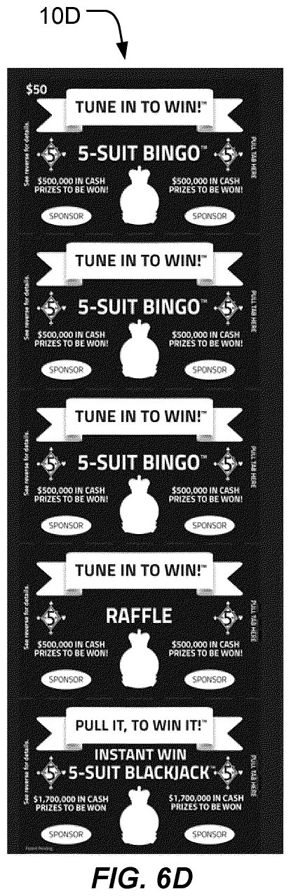

The gaming tickets may include means for identifying winning conditions of the games, which include at least one game symbol or indicia eligible to be a winning game symbol or indicia, as identified by the associated instructions provided for each game, on each playing surface. For example, a physical version or embodiment of the gaming ticket may include an outer front surface 10A, an inner front surface 10B, an inner rear surface 10C, and an outer rear surface 10D (e.g. see FIG. 6). Outer front surface 10A may provide general information like the types of games supported by the ticket, the number of games in the ticket, the sponsors of the games, the prize amount, etc. (e.g. see FIG. 6A). Inner front surface 10B may provide a shade of black or other opaque colors to prevent players from seeing through the front surface of the ticket (e.g., see FIG. 6B). Inner rear surface 10C may provide the games (e.g., see FIG. 6C showing five games provided on inner rear surface 10C). Outer rear surface 10D may provide further information, including game-specific information like the gameplay rules and winning conditions for the games (e.g., see FIG. 6D.

Gaming tickets described herein may support a wide variety of games, including but not limited to games of skill and/or chance that are based on one or more of: “21”, “21 Blackjaccarat”, “In-Between 21”, In-Between 21 Blackjaccarat“, “Escalator 21”, “Escalator Blackjaccarat”, “Blackjack”, “Blackjaccarat”, “In-Between Blackjack”, “In-Between Blackjaccarat”, “Escalator Blackjack”, “Escalator Blackjaccarat”, “Baccarat”, “Mini Baccarat”, “Bingo”, “War Battle”, “War Battlerat”, “Faro”, “In-Between Poker”, “In-Between Pokerat”, “Pai Gow Poker”, “Pai Gow Pokerat”, “Poker Bingo”, “Pokerat Bingo”, “Poker-5 Card Stud”, “Pokerat-5 Card Stud”, “Poker-Omaha”, “Pokerat-Omaha”, “Poker-Texas Hold'em”, “Pokerat-Texas Hold'em”, “Roulette”, “Rummy”, “Rummy 21”, “Up & Down Rummy”, “Solitaire”, “Craps”, “Keno”, and “Sic Bo”.

A game of skill is based primarily on the mental or physical level of expertise of a player, rather than chance. One benefit of this type of game is that it provides freedom to the players to explore their capabilities in the game. Games of skill typically encourage the players to become accustomed to a certain set of rules while looking for ways to improve and implement different strategies through consistent practice. While some games of skill may have a chance component to a certain extent, their expected outcome(s) and winning condition(s) are primarily determined by the individual player's skills. Exemplary games of skill include, but are not limited to: “Chess”, “Carrom”, “Rummy”, “Teen Patti”, “Horse Racing” and “Fantasy Sports”.

A game of chance has expected outcome(s) and winning condition(s) that are determined or heavily influenced by one or more random factors. The random factors may be of any type. For games of chance, players typically have limited or no control over the expected outcome. While some games of chance may require or involve some levels of skill, their expected outcome(s) and winning condition(s) are primarily determined by chance. These types of games may include games that are based on playing cards, rolling a dice, drawing a numbered ball, etc. Exemplary games of chance include, but are not limited to “Blackjack” and “Roulette”.

The awards for winning in the primary games or secondary games may comprise a monetary value. At least a portion of the game symbols or indicia may comprise numeric designations. Further, at least one game symbol or indicia of at least one game may be an instant-winning game symbol or indicia, and/or may be another winning game symbol or indicia and/or may be a bingo winning game symbol or indicia, and/or afford a further opportunity using the same purchased ticket at a second-use opportunity to win a monetary and/or other identified prize, sponsored or otherwise. At least one of the games may include symbols or indicia which indicates a plurality of classes of winning game symbols or indicia. This symbol or indicia indicates whether an individual game symbol or indicia is within a class of instant-winning game symbols or indicia, or is within a class of game symbols or indicia which is eligible to be a winning game symbol or indicia as identified by the indicated instructions.

In some electronic or computer-implemented embodiments, providing a ticket may comprise displaying ticket 10 through a graphical user interface (GUI) on one or more screens. In some electronic or computer-implemented embodiments, providing or assigning a set of values to a play area may comprise displaying the values through the GUI.

In some non-electronic embodiments, providing a ticket may comprise printing the ticket 10 onto a physical substrate, such as cardboard paper or the like. In some non-electronic embodiments, providing or assigning a set of values to a play area may be achieved by way of design before ticket 10 is printed onto the physical substrate.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments” or in “one embodiment”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

1. A method for conducting a lottery-type game comprising:
providing a ticket comprising first and second play areas, the first and second play areas each supporting a primary lottery-type game defined by gameplay rules and one or more winning conditions;
assigning a first set of values to the first play area based on at least one of the winning conditions of the first primary game to facilitate gameplay of the first primary game; and
assigning a second set of values to the second play area based on at least one of the winning conditions of the second primary game to facilitate gameplay of the second primary game,
wherein a winning value satisfying one of the winning conditions of the second primary game is dependent on the first set of values.

2. The method of claim 1, wherein a second winning value satisfying a second one of the winning conditions of the second primary game is independent of the first set of values.

3. The method of claim 1, wherein a winning value satisfying one of the winning conditions of the first primary game is dependent on the second set of values.

4. The method of claim 3, wherein a second winning value satisfying a second one of the winning conditions of the first primary game is independent of the second set of values.

5. The method of claim 1, wherein the first and second play areas collectively support a secondary lottery-type game defined by gameplay rules and one or more winning conditions.

6. The method of claim 5, wherein, wherein a first winning value satisfying a first one of the winning conditions of the secondary game is dependent on the first set of values and the second set of values.

7. The method of claim 6, wherein a second winning value satisfying a second one of the winning conditions of the secondary game is independent of the first set of values and dependent on the second set of values.

8. The method of claim 1, wherein the first primary game is an instant win game, a raffle game, or an interactive game.

9. The method of claim 1, wherein the secondary game is an instant win game, a raffle game, or an interactive game.

10. An instant gaming ticket comprising:
a first play area providing a first set of values for play in a first primary lottery-type game defined by gameplay rules and one or more winning conditions; and
a second play area providing a second set of values for play in a second primary lottery-type game defined by gameplay rules and one or more winning conditions,
wherein a winning value satisfying one of the winning conditions of the second primary game is dependent on the first set of values.

11. The instant gaming ticket of claim 10, wherein the first play area and the second play area are located on the same surface.

12. The instant gaming ticket of claim 11, wherein the second play area is located beneath or adjacent to the first play area.

13. The instant gaming ticket of claim 10, wherein the first play area and the second play area are located on different surfaces.

14. The instant gaming ticket of claim 10, comprising a cover for concealing the first set of values.

15. The instant gaming ticket of claim 14, wherein the cover comprises an opaque scratch-off coating.

16. The instant gaming ticket of claim 14, wherein the cover comprises a removable flap.

17. The instant gaming ticket of claim 10, comprising a third play area providing a third set of values for play in a third primary lottery-type game defined by gameplay rules and one or more winning conditions.

18. The instant gaming ticket of claim 17, wherein a winning value satisfying one of the winning conditions of the third primary game is dependent on the first set of values.

19. The instant gaming ticket of claim 17, wherein a winning value satisfying one of the winning conditions of the third primary game is dependent on the second set of values.

20. The instant gaming ticket of claim 10, wherein a winning value satisfying a winning condition of a secondary game is dependent on the first set of values and the second set of values.

21. A computer-implemented method for conducting a lottery-type game comprising:
defining gameplay rules and one or more winning conditions for each of a first primary game and a second primary game;
providing in a first play area a first set of values randomly generated based on the gameplay rules of the first primary game; and
providing in a second play area a second set of values randomly generated based on the gameplay rules of the second primary game, wherein a winning value satisfying one of the winning conditions of the second primary game is dependent on the first set of values.

22. The computer-implemented method of claim 21, wherein the second primary game is an interactive game.

23. The computer-implemented method of claim 21, comprising announcing the winning condition of the second primary game after providing the first and second set of values in the first and second play areas.

24. (canceled)

25. (canceled)
